(19) United States
(12) Patent Application Publication
(10) Pub. No.: US 2003/0085274 A1
(43) Pub. Date: May 8, 2003

(54) Genetic tag (DNA-tag) identification system for newborns, adults, plants and animals

(76) Inventors: John Roger Leaton, Houston, TX (US); Rahul Mitra, Pearland, TX (US)

Correspondence Address: John R. LEATON, 13726 Tosca Lane, Houston, TX, 77079, US

(21) Appl. No.: 10/288,928

(22) Filed: Nov. 6, 2002

Related U.S. Application Data
(60) Provisional application No. 60/332,721, filed on Nov. 6, 2001.

(51) Int. Cl. G06K 5/00

(52) U.S. Cl. 235/380

(57) ABSTRACT

A wearable physical tag with miniaturized (to scale) micro scale, unique DNA profile genetic information (DNATAG™) has been devised for newborns, adults, and animals which is used to test for newborn babies and parents in post-operative and release from hospitals, for clinical evaluation of adults in genetic identifications, for pre and post operative situations, for identification of missing persons and for long term clinical genetic family histories of adults. This invention would also be used in testing and identification of sport, domestic, or wild animals in lost and found conditions, including breeding characteristics. The DNATAG™ could be integrated into the existing means of identification, namely, Driver's licenses, Passports, Credit Cards, automated door keys and other such forms of ID. In addition, the DNATAG™ could be worn as a tag by an individual. This universal format (encompassing barcode, or any other means of representing the DNA profile on to a physical manifestation) of the DNATAG™ is read by a reader that would convert the micro scale DNA profile representation and compare the profile for the individual/animal with his/her's profile on record on a secure database. The invention also could be manifested in the form of a barcode, or any other such representations of the DNA profile.

### SPECIFICATION

This application claims the benefit of U.S. Provisional Application Serial No. 60/332,721 filed Nov. 6, 2001.

### FEDERALLY SPONSORED RESEARCH

Not Applicable

### SEQUENCE LISTING OR PROGRAM

Not Applicable

### FIELD OF INVENTION

DNATAG™ is a physical tag containing a miniaturized (to scale) unique DNA fingerprint/profile pattern for each of the individual or organism. The physical tag could be made using lithography, photolithography, chemical etching, electrolysis deposition, scratching of the surface, film transfer, nano scale writing, painting, deposition of ink on metal, plastic, silica and other solid substrates in wafer, slide or a wearable format. The DNATAG™ could be integrated into the existing means of identification, namely, driver's licenses, passports, credit cards, automated door keys and other such forms of ID. In addition, the DNATAG™ could be worn as a tag by an individual. This universal format of the DNATAG™ is read by a reader that would convert the micro scale DNA profile representation and compare the profile for the individual/animal with his/her's profile on record on a secure database. The DNATAG could also be used to identify any infant, adult of any animal and plants.

### DESCRIPTION OF THE RELATED ART

One of the major problems that are faced by the law enforcement authorities globally is the reliability in personal identification. Current common methodologies used as a means of identification of an individual are numerical methods like social security number, birth date, and photographs. These methods are easily forged, due to an increase in electronic and computer capabilities. Other methods, which are more exotic, are fingerprinting, and retinal scans. These methods are not very easily enforceable due to the lack of databanks of fingerprints and requirement of hardware to read them. By far one of the clearest methods of identification of an individual is DNA fingerprinting. A DNA fingerprint is a pattern generated by cutting a DNA chromosome with restriction enzymes and separating the pieces by electrophoresis to generate a unique pattern, the “fingerprint” or “profile” pattern for each species, breed, hybrid, or individual, depending on which enzymes and probes are used. This technique is being used by several states and law enforcement agencies for both convicting and acquitting the accused. California and Massachusetts are among a number of states considering plans to create a computerized generic database using blood and saliva samples of all those convicted of violent crimes. The Federal Bureau of Investigation is seeking to develop a standard national classification system and is helping states adopt the technology. Several congressional committees have held hearings recently on the issue of a national standard.

### STATE OF THE ART

DNA fingerprinting/profiling is being used primarily for the purpose of either conviction or acquittal in the legal process. There are now examples of other applications for this technology, namely, use of the DNA fingerprints for the identification of an individual for purposes other than legal use (Biowell Corporation, Taiwan,) While the use of DNA fingerprinting is still in its infancy, it is expected to become a major means of identification in the near future.

Irrespective of the method used to identify an individual, the representation of the principle component (example a barcode, numerical ID, photograph etc.) in the form of a tag or a badge is common practice. The reliability of the identity is largely dependent on the representation of the primary component of the identification method. Hence there is a need to develop a simple representation method for the identification of an individual.

Several methods are currently used to identify an individual. Most common ones are numbers, barcodes, and photographs. All these methods are easily tampered with. Other less common experimental methods include fingerprints and retinal scans. These methods are probably tamper proof, but are cumbersome to implement.

Other methods that are becoming available are nanotechnology based, where in several nano particles are typed with a specific barcode (Surromed Mountainview, Calif.) to be used for specific identification of a particular DNA. This technology is still in its infancy to be used as a routine technique.

The above methods of representation could easily be tampered and hence a more robust method of identification is required. While several methods strive to verify the identity of the bearer of the identification card or implement, none of the methods provide a built in verification system as powerful as a DNA fingerprint.

Forms of representation of a DNA fingerprint on an identification card or a tag are restricted to actual placement of a specific characterized DNA from a different organism or a synthetic DNA that would glow after it binds its complementary strand labeled with a fluorescent dye. Other examples include use of fluorescent-labeled synthetic pieces of DNA suspended in inks (Biowell Corporation, Taiwan) for labeling personal possessions.

### SUMMARY

The present invention aims to provide a new and improved method to represent a form of identification of an individual based on their DNA fingerprint. The present invention uses a miniaturized image of the actual pattern of a DNA fingerprint of an individual to be used as an identification method.

Advantages of the invention include:

(a) ᵣₑₛᵤₗₜ format to allow for clinical and evaluative data to be available for future use as needed for clinical, identity, or genetic profiling.

(b) DNA-TAG™ consists of a miniaturized pattern of the DNA profile on a physical tag in several formats on glass, metal, alloy, plastic or any synthetic or inorganic material.

(c) DNA-TAG™ consists of a CCD, laser or white light reader that could decode the miniaturized information on the physical tag.

(d) DNA-TAG™ consists of an algorithm that could interpret the results and compare with the original profile stored in a secure database.

(e) Results would allow for the prevention of crime related to identification.

(f) Results would allow a better means of identification of passports for security purposes.

(g) The system is easily verifiable from the person's own blood, saliva etc. samples.

(h) Individualized protection system for any of the valuable personal effects.

(i) The invention also could be manifested in the form of a barcode, or any other such representations of the DNA profile.

(i) A fail-safe method for the identification of prized animals and pets.

### BRIEF DESCRIPTION OF THE DRAWINGS

FIG. 1 presents the miniaturization of a DNA fingerprint pattern. 1 is the original size of the DNA fingerprint, 2 is the midsize and 3 is the miniaturized form of the DNA fingerprint pattern.

FIG. 2 represents a DNA tag onto which the DNA fingerprint pattern could be transferred. 1 is DNA-TAG similar in dimensions of a driver's license card, and 2 is a DNA-TAG similar to a military dog tag, where the DNA fingerprint pattern might be either visible or invisible to the naked eye.

FIG. 3 represents the DNA tag with DNA fingerprint being encoded and decoded. 1 is encoding of the DNA-TAG and 2 is the reading of the DNA-TAG by any of the methods described above to regenerate the original DNA fingerprinting pattern.

### DETAILED DESCRIPTION OF THE INVENTION

The invention assumes a laboratory knowledge of the process of acquiring the sample as would be stated in forensic and general Molecular Biology laboratory journals and manuals, and the common processes associated with those procedures. In an effort to help clarify those more important points in the invention, the following discussion is given:

Samples of blood, urine, or other physiological components of the body are taken and properly preserved for DNA preparation. This also assumes the taking of samples for plants, animal tissue or components, which would represent a sample of the targeted specimen for further examination. For complete information, the following references on sample preparation and molecular biological protocols are listed as follows:

1) Testing for Genetic Manipulation in Plants (Molecular Methods of Plant Analysis, V.22, J F Jackson, et.al

2) Purification of plasmid DNA (miniprep) with high yields using Diatomaceous earth, Kyung-Soo Kim and Charles K. Pallaghy

3) School of Botany, La Trobe University, Bundoora Vic 3083, Australia Birnboim, H. C. 1983. A rapid alkaline extraction method for the isolation of plasmid DNA. Methods Enzymol. 100, 243-255

4) Gel Sequencing. Mark Strom, US Dept. of Commerce URD/NWFSC Oct. 27, 1995

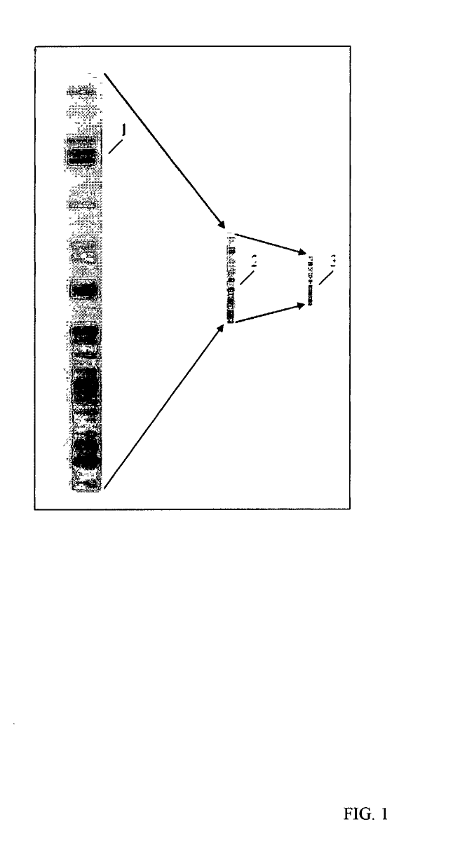

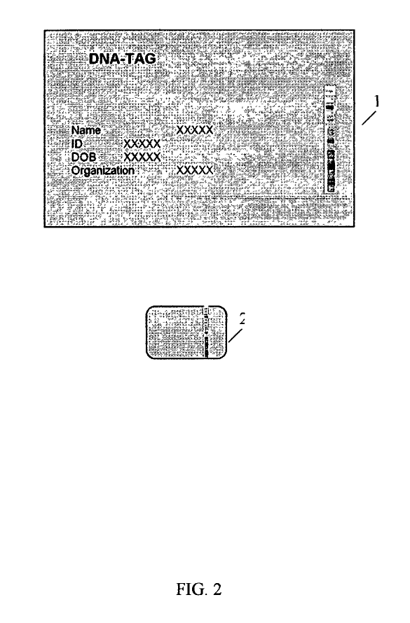

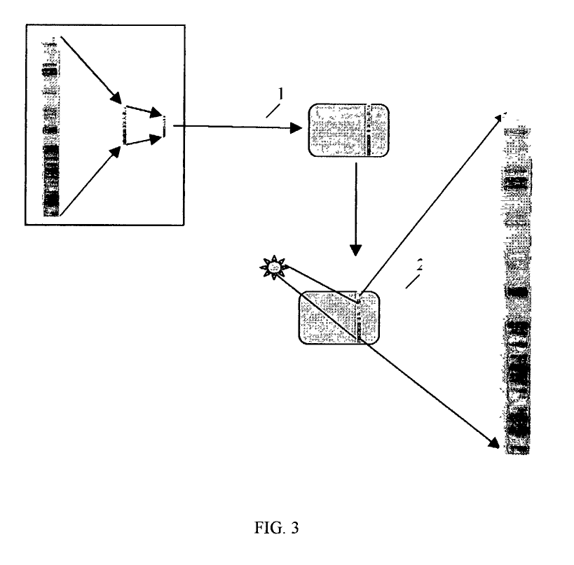

After the DNA has been scanned from the electrophoresis pattern that separates the encoded DNA into its respective bands of identification, the scan is miniaturized from the original size of the DNA profile or fingerprint. (FIG. 1). The individual choice of the media or object onto which the profile or fingerprint is transferred is optional depending on the desired application, i.e., a plastic card, a drivers license, or a small synthetic chip, etc. (FIG. 2) The invention is comprised of a process of general known laboratory procedures being applied to the extraction of DNA and then prepared from the scanned image to identical small patterns to be used for future identification of the plant, animal, or human. Therefore, as given in FIG. 3, the encoded or read profile is interpreted as to its descriptive bands and read by a suitable laboratory reader for that given presentation. The following general steps are given to describe the method.

The process of the invention method is related to the use of a miniaturized image of a DNA fingerprint of an individual by (1) obtaining the DNA fingerprint (2) miniaturizing the image by conventional imaging techniques (3) transferring the miniaturized DNA fingerprint pattern to a tag (4) using the tag with the DNA fingerprint permanently imprinted as a means of identification of the bearer of the tag (5) verification of the identity could be done by comparing the DNA finger printing pattern to an existing pattern or by generating the DNA fingerprint of the bearer.

The present invention offers an easy and reliable method to use the DNA fingerprinting technology as a means of identification. The surprising finding is that although DNA fingerprinting is used in the legal system, and much debate has been going on to adopt it as a standard, no miniaturized representation has been contemplated or implemented until now.

The present invention comprises of the DNA fingerprint image miniaturized and transferred to a tag comprised of a material including and not limited to plastic, metal, glass, paper, cloth, synthetic material like a polymer and the like.

The present invention comprises of the DNA fingerprint image miniaturized and transferred to a tag using microprocessor-manufacturing methods like photolithography, nano writing by scratching the surface of the tag, or simply the extremely miniaturized image.

The present invention comprises of the DNA fingerprint image that could be reduced from a few centimeters to a few microns that could be read using simple microscopes to a laser scanner.

The present invention comprises of the DNA fingerprint image that could be transferred electronically to obtain a comparative match with the bearer's original record, easily over either an interconnected network or wireless network, due to the miniaturized size of the image.

We claim:

1. A method of preparing a miniaturized image of a DNA fingerprint or profile of an individual, plant, or animal comprising the steps of:
(i) obtaining a DNA fingerprint/profile using standardized procedures;
(ii) miniaturizing the DNA fingerprinting/profile image by conventional imaging techniques;
(iii) transferring the miniaturized DNA fingerprint/profile pattern to a tag;
(iv) using the tag with the DNA fingerprint/profile permanently imprinted as a means of identification of the bearer of the tag;
(v) decoding the information on the physical tag using a CCD, laser or white light reader;
(vi) comparing the results with the original profile stored in a secure database; and
(vii) organizing the result format to allow for clinical and evaluative data to be available for future use as needed for clinical, identity, or genetic profiling.
